(19) United States
(12) Patent Application Publication
(10) Pub. No.: US 2025/0096916 A1
(43) Pub. Date: Mar. 20, 2025

(54) A METHOD FOR IMPROVING COMMUNICATION BY A WIRELESS DEVICE, RELATED NETWORK NODE AND RELATED WIRELESS DEVICE

(71) Applicant: Sony Group Corporation, Tokyo (JP)

(72) Inventors: Chaitanya TUMULA, Åkarp (SE); Erik BENGTSSON, Eslöv (SE); Fredrik RUSEK, Eslöv (SE); Jose FLORDELIS, Lund (SE); Kun ZHAO, Malmö (SE); Olof ZANDER, Södra Sandby (SE); Ying ZHINONG, Lund (SE)

(21) Appl. No.: 18/724,453

(22) PCT Filed: Dec. 13, 2022
(86) PCT No.: PCT/EP2022/085568

§ 371 Date: Jun. 26, 2024

(30) Foreign Application Priority Data
Jan. 10, 2022 (SE) 2250012-8

(51) Int. Cl. H04B 17/345; H04W 28/02

(52) U.S. Cl. CPC H04B 17/345; H04W 28/0236

(57) ABSTRACT

A method is disclosed performed by a network node of a communications network, for improving communication by a wireless device, WD. The method comprises transmitting, to the WD, a message indicating that a change of an interference state in the communications network will occur.

The present disclosure pertains to the field of wireless communications. The present disclosure relates to a method for improving communications by a wireless device, a method for performing interference measurements by the wireless device, a related network node and a related wireless device.

### BACKGROUND

Coverage enhancing devices (CED), such as smart repeaters and reflective intelligent surfaces (RIS), can provide coverage enhancement for devices using 5G and beyond. Coverage enhancing devices can be used for beamforming, such as to or from a base station. Coverage enhancing devices can be used to improve signal coverage, for example at hard-to-reach locations, or transitions from outdoors to indoors. Certain coverage enhancing devices can be reconfigurable, such as having the ability to choose a phase shift per coverage enhancing device antenna. For given incoming and outgoing angles, an optimal phase setting can be obtained. However, a significant problem is that such phase setting is not limited to reflecting the configured—for incoming and outgoing signal directions but is in fact reflecting a wide range of other directional pairs with the same beamforming gain as for the configured—for incoming and outgoing signal directions. This is because, in general, any input angle has an associated output angle for a specific configuration, herein referred to as parasitic reflections. One unwanted side-effect of CEDs is that they can cause increased interference in a wireless communication system due to the mentioned parasitic reflection. This can negatively affect communication by a wireless device in the wireless communication system. The problem may be even larger if the CED applies gain to the reflected signals.

### SUMMARY

Accordingly, there is a need for network nodes, wireless devices and methods performed therein for improving communication by a wireless device, which may mitigate, alleviate or address the shortcomings existing and may provide an improved performance by the wireless device.

A method is disclosed performed by a network node of a communications network, for improving communication by a wireless device, WD. The method comprises transmitting, to the WD, a message indicating that a change of an interference state in the communications network will occur.

Further, a network node is provided, the network node comprising memory circuitry, processor circuitry, and a wireless interface, wherein the network node is configured to perform any of the methods disclosed herein and relating to the network node.

It is an advantage of the present disclosure that the network node can inform the wireless device about a change in interference conditions, such as a change in interference levels, in the wireless communications network. This enables the wireless device to adapt its interference measurements based on the change of interference states in the wireless communications network

A method is disclosed performed by a wireless device, WD, for performing interference measurements by the WD. The method comprises receiving, from the network node, a message indicating that a change of an interference state in a network will occur. The method comprises adapting an interference measurement based on the indicated change of the interference conditions.

Further, a wireless device is disclosed, the wireless device comprising memory circuitry, processor circuitry, and a wireless interface, wherein the wireless device is configured to perform any of the methods disclosed herein and relating to the wireless device.

It is an advantage of the present disclosure that the WD can be informed about changing interference conditions, such as interference levels, in the wireless communications network. This enables the wireless device to adapt its interference measurements based on the change of interference conditions in the wireless communications network, based on which the WD can adapt a computation of an interference covariance matrix for mitigating an impact of the interference on the communication with the network node.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node, an example wireless device and an example coverage enhancing device according to this disclosure,

FIG. 2A-2B are diagrams illustrating respective example interference scenarios caused by different states of a coverage enhancing device according to the current disclosure,

FIG. 3 is a diagram illustrating an example interference level at a wireless device for different states of a coverage enhancing device,

FIG. 4 is a flow-chart illustrating an example method, performed in a network node of a wireless communication system, for improving communication by a wireless device according to this disclosure,

FIG. 5 is a flow-chart illustrating an example method, performed in a wireless device, for performing interference measurements by the WD according to this disclosure,

FIG. 6 is a diagram illustrating an example solution for handling changing interference level at the wireless device for different states of a coverage enhancing device according to the current disclosure,

FIG. 7 is a block diagram illustrating an example network node according to this disclosure, and

FIG. 8 is a block diagram illustrating an example wireless device according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

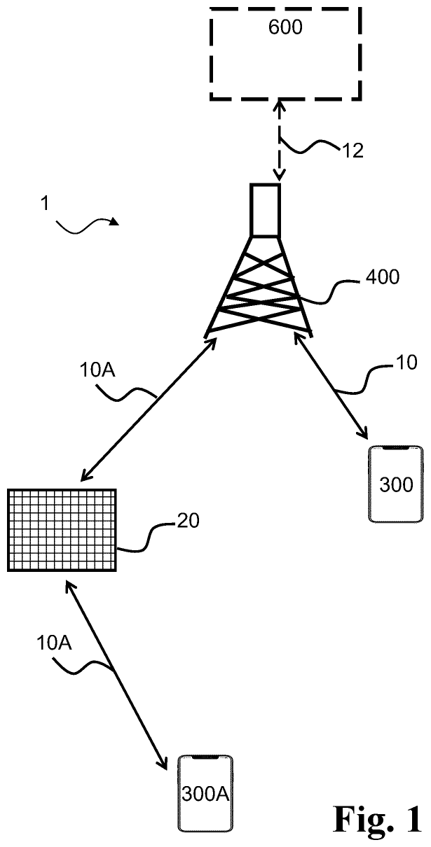

FIG. 1 is a diagram illustrating an example wireless communication system 1 according to this disclosure. The wireless communication system 1 comprises a wireless device 300, a wireless device 300A, a network node 400 and a core network (CN) node 600.

As discussed in detail herein, the present disclosure relates to a wireless communication system 1 comprising a cellular system, for example, a 3GPP wireless communication system.

A network node disclosed herein refers to a radio access network (RAN) node operating in the radio access network, such as a base station, an evolved Node B, eNB, gNB in NR.

In one or more examples, the RAN node is a functional unit which may be distributed in several physical units.

The CN node disclosed herein refers to a network node operating in the core network, such as in the Evolved Packet Core Network, EPC, and/or a 5G Core Network, 5GC. Examples of CN nodes in EPC include a Mobility Management Entity, MME.

In one or more examples, the CN node is a functional unit which may be distributed in several physical units.

The wireless communication system 1 described herein may comprise one or more wireless devices 300, 300A, and/or one or more network nodes 400, such as one or more of: a base station, an eNB, a gNB and/or an access point.

A wireless device may refer to a mobile device and/or a user equipment (UE).

The wireless device 300, 300A may be configured to communicate with the network node 400 via a wireless link (or radio access link) 10, 10A.

In one or more examples, the wireless communication system 1 may comprise a coverage enhancing device (CED) 20. The CED may be one or more of a smart repeater and a reflective intelligent surface (RIS). The CED may provide coverage enhancement for devices using 5G and beyond. The CED 20 may be configurable by the network node 400 and may be used to improve signal coverage in the wireless communication system 1. The CED 20 may be used to forward data between the network node 400 and the WD 300A when the WD 300A is located at hard-to-reach locations, such as at a border of a coverage area of the network node 400 or when a direct link between the network node 400 and the WD 300A is obstructed. The wireless device 300A may be configured to communicate with the network node 400 via the wireless link (or radio access link) 10A via the CED 20.

The WD 300, 300A may continuously measure interference experienced by the WD in the wireless communication system 1. The measured interference can be reported to the network node 400, such as to the gNB, and/or can be used internally by the WD 300, 300A when decoding data. An interference pattern might change depending on an operating mode of the CED 20. The WD 300, 300A may for example observe one interference pattern when the CED 20 is operating in a first state, such as using a first configuration, and another interference pattern when the CED 20 is operating in a second state, such as using a second configuration. In one or more example methods, the first configuration may be a first beam configuration, such as a beam configuration configured to serve a first WD. In one or more example methods, the second configuration may be a second beam configuration, such as a beam configuration configured to serve a second WD. In one or more example methods, the first configuration may be an ON mode and the second configuration may be an OFF mode of the CED 20. Thus, according to the current disclosure, the network node 400 can signal the WD 300, 300A about a change in the interference to enable the WD 300, 300A to adjust its interference measurement for decoding the WD's own data. The ON-state may herein be a state in which the CED 20 is controlled, such as by a network node, to beam-form communication between the network node 400 and the WD 300A. In one or more example methods, the OFF-state may be a state in which the CED 20 is not controlled, such as by the network node, to beam-form communication between the network node 400 and the WD 300A. In one or more example methods, the OFF-state may be a power OFF state, a state corresponding to a beamforming configuration in which the CED may scatter signals reaching the CED, or a state in which the CED operates with a lower gain configuration.

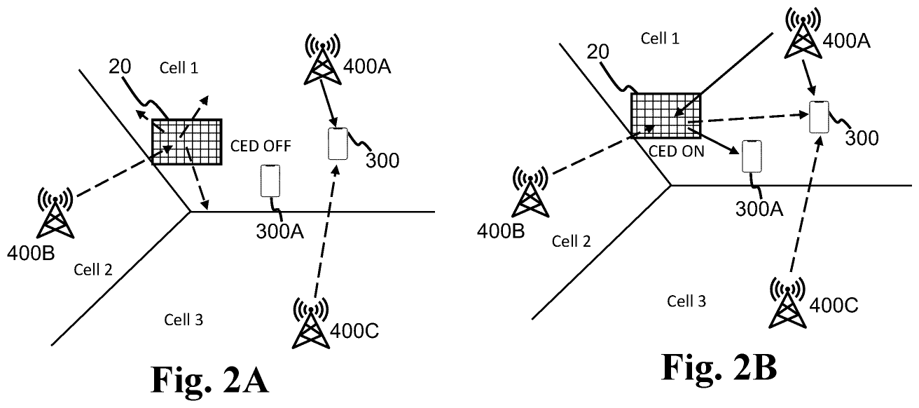

FIGS. 2A and 2B illustrate example interference scenarios caused by different states of the CED 20. In FIG. 2A the CED 20 is in an OFF-state and in FIG. 2B the CED 20 is in an ON-state. In the illustrated scenario, the wireless communication system comprises a first network node 400A, a second network node 400B and a third network node 400C serving a respective cell, in FIGS. 2A and 2B referred to as Cell 1, Cell 2, and Cell 3, a CED 20, and two WDs 300, 300A as shown in FIG. 1. The first network node 400A serves a first WD 300A via the CED 20 and serves the second WD 300 directly (not through the CED 20) in the first cell, herein referred to as Cell 1. When the CED 20 is in the OFF state (such as when the gNB1 is not serving the first WD 300A) as shown in FIG. 2A, a signal from the second network node 400B may be scattered by the CED 20 and may not reach the second WD 300. The second WD 300 may only experience interference coming from the third network node 400C in Cell 3. However, when the CED 20 is in the ON state as shown in FIG. 2B and the first network node 400A is sending data through the CED 20 to the first WD 300A, a signal from the second network node 400B may be unwantedly reflected through the CED 20 to the second WD 300. The unwanted reflection through the CED 20 may occur even if the CED 20 is configured only to reflect the signaling coming in from the first network node 400A to the first WD 300A. Hence, when the CED 20 is in the ON state, the second WD 300 will experience interference from the second network node 400B in cell 2 and the third network node 400C in cell 3.

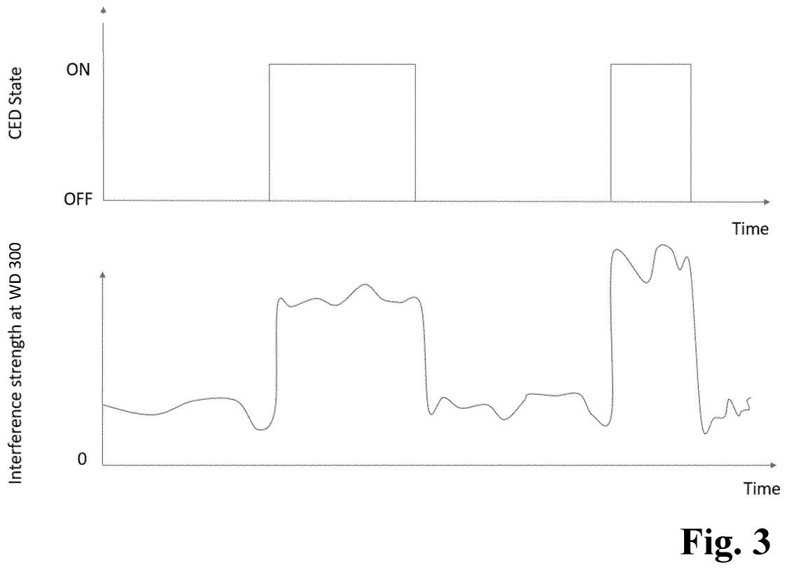

FIG. 3 illustrates an interference strength experienced at the WD 300 during a switching of the CED between the ON-state and the OFF-state in the example scenarios shown in FIGS. 2A and 2B. In the scenario described in FIGS. 2A and 2B, the WD 300 may observe different interference signal strengths and patterns depending on the state of the CED. As can be seen in FIG. 3, the interference level experienced by the WD 300 is higher during the ON-duration of the CED than during the OFF-duration of the CED. Typically, an interference covariance matrix estimation is used for improved data detection by the WD 300, and the interference covariance matrix estimation may be averaged over a certain time duration (such as over multiple slots or multiple symbols). If there is a change in configuration of the CED during the time duration over which the interference covariance matrix estimation is performed, this can lead to a performance degradation for the WD 300. The interference covariance matrix can be used by the WD 300 to reduce the impact of the interference on the data communication over a channel with the network node. For example, the interference covariance matrix can in general be used for interference cancellation, for pre-whitening the received signal or for performing interference rejection combining. The current disclosure thus proposes a method where the WD 300 may be informed about a change of the interference state of the network, so that the WD 300 can adapt its interference measurement based on the changing interference states.

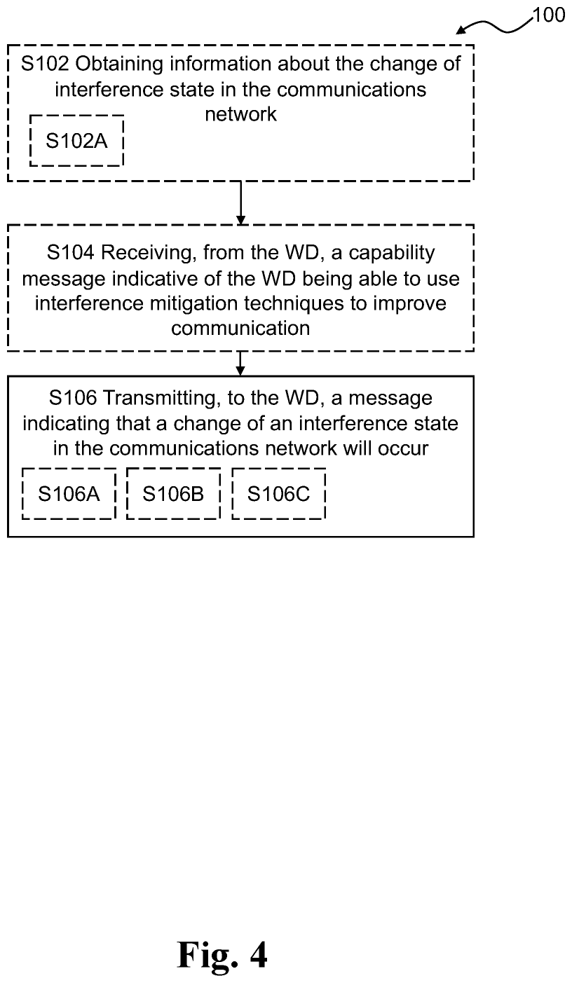

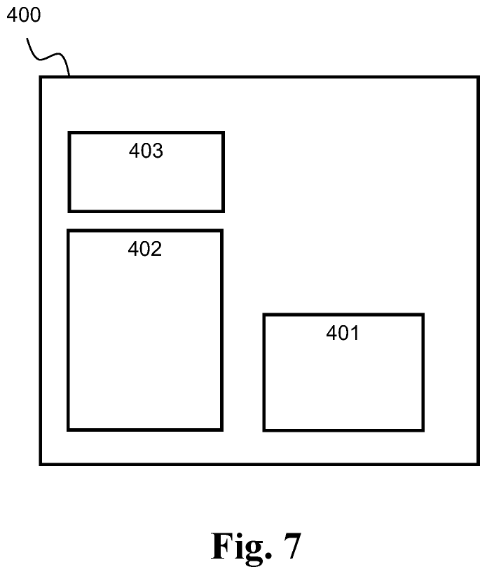

FIG. 4 shows a flow diagram of an example method 100, performed by a network node according to the disclosure, for improving communication by a WD. The network node is the network node disclosed herein, such as network node 400 of FIG. 1, FIG. 2, and FIG. 7.

In one or more example methods, the method comprises obtaining S102 information about the change of interference state in the communications network. In one or more example methods, the network node can control the change of interference state, such as control a configuration of the CED, such as control a change of the configuration of the CED. When the network node can control the change of the interference state, it may be aware of the changes that may occur and when they may occur. In one or more example methods, the change of the interference state may be controlled by a second network node, such as due to a change of a configuration in a CED controlled by the second network node. When the change of the interference state is controlled by a second network node, obtaining S102 may comprise receiving S102A the information about the change of interference state in the communications network from the second network node.

In one or more example methods, the method comprises receiving S104, from the WD, a capability message indicative of the WD being able to use interference mitigation techniques, such as restarting, resetting, or adapting interference calculations, to improve communication. The capability message may indicate that the WD is an advanced receiver capable of performing interference mitigation and/or cancellation, such as based on interference calculations.

The method 100 comprises transmitting S106, to the WD, a message indicating that a change of an interference state in the communications network will occur. The interference state may herein be seen as an interference level, such as an interference signal strength, and/or a spatial structure of the interference experienced by the wireless device. The message indicating the interference state may thus be indicative of a change in the interference level and/or a spatial structure of the interference experienced by the wireless device.

The message indicating that a change of an interference state in the communications network will occur can inform the WD about the possibility of a change in interference observed by the WD. The change in interference observed by the WD may be due to one or more of a change in the network node configuration, a change in a network node transmit (Tx) beam, a change of a network configuration, such as adding or removing a CED or a new network node joining the network, or due to a configuration change of a CED controlled by the network node.

In one or more example methods, the message may comprise a timing indication indicative of when the change of the interference state will occur. The timing indication can be implicit e.g., relative to the timing, such as the time of transmittal or receival of the message, or explicit.

In one or more example methods, the change of the interference state is associated with the coverage enhancing device, CED, in the communications network. The first interference state may be caused by a first configuration of the CED, and the second interference state may be caused by a second configuration of the CED. The first configuration of the CED may be an ON-state of the CED. The second configuration of the CED may be an OFF-state of the CED.

In one or more example methods, the first interference state may be caused by the CED performing nulling and the second interference state may be caused by the CED not performing nulling. Nulling means that an antenna array of the CED may use a phase distribution to have minimum signal level in a predetermined direction.

In one or more example methods, the change of the interference state is associated with a transition between a first interference state and a second interference state. The first interference state may be due to a first state of the CED, such as an ON-state or a first beamforming state of the CED. The second interference state may be due to a second state of the CED, such as an OFF-state or a second beamforming state of the CED.

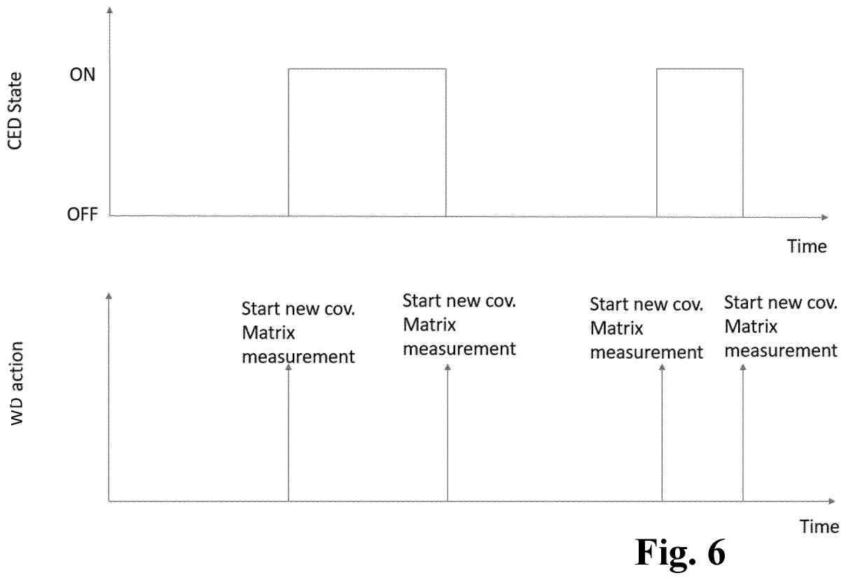

In one or more example methods, the message is indicative of a pattern of one or more transitions between the first interference state and the second interference state. The pattern may indicate at which times a transition between the first interference state and the second interference state may occur. In one or more example methods, the pattern may be associated with the transitions of the CED from a first state, such as from a first configuration of the CED, to a second state, such as to a second configuration of the CED, as shown in FIG. 6.

In one or more example methods, the pattern is indicative of one or more of a duration of the first interference state and a duration of the second interference state. The duration of the first interference state and/or the second interference state may be an ON duration and/or OFF duration of the CED.

In one or more example methods, the message is indicative of a time instance when the change of the interference state will occur. The time instance may be indicated as a time offset from the transmission of the message, such as a time offset from a time stamp of the message.

In one or more example methods, the message is indicative of one or more beamforming patterns used or to be used at the CED during the first state or the second state. The beamforming pattern may be implicitly or explicitly indicated in the message. The different beamforming patterns of the CED results in the CED redirecting signals in different directions. Hence, the interference situation experienced by the WD may change.

In one or more example methods, the message is transmitted using one or more of a physical (PHY) layer signaling using downlink control information (DCI), a medium access control-control element (MAC-CE) signaling, and/or a Radio Resource Control (RRC) signaling.

In one or more example methods, transmitting S106 comprises transmitting S106A the message based on the capability message. The network node may determine, based on the capability message, whether the wireless device is capable of using the interference mitigation techniques, such as restarting, resetting and/or adapting interference calculations, to improve communication. Upon determining that the WD is capable of using the interference mitigation techniques, the network node may transmit the message to the WD. Upon determining that the WD is not capable of performing interference mitigation techniques, such as restarting, resetting and/or adapting interference calculations, the network node may refrain from transmitting the message to the WD.

In one or more example methods, transmitting S106 comprises transmitting S106B a unicast message. In other words, the network node may transmit dedicated messages to WDs being capable of using interference mitigation techniques to improve communication.

In one or more example methods, transmitting S106 comprises broadcasting S106C the message. The network node may transmit the message, such as signal the possibility of a change in interference state to all or a selected set of WDs connected to the network node. The message may thus be received by a WD regardless of whether the WD is capable of using interference mitigation techniques to improve communication based on the message.

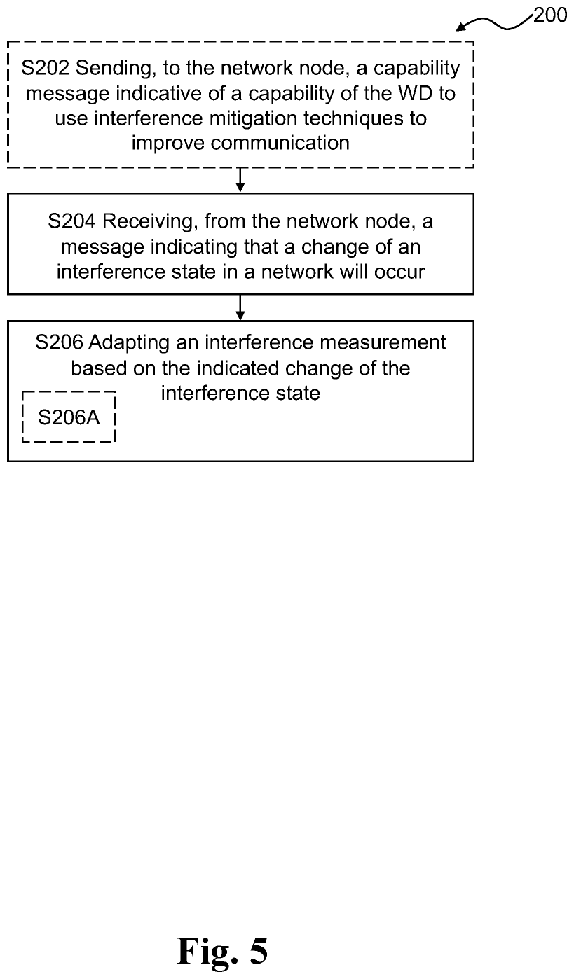

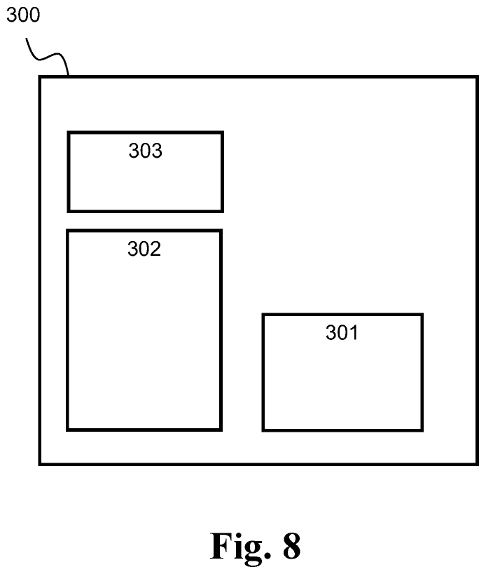

FIG. 5 shows a flow diagram of an example method 200, performed by a wireless device according to the disclosure, for performing interference measurements by the WD. The wireless device is the wireless device disclosed herein, such as wireless device 300 of FIG. 1, FIG. 2, and FIG. 8.

In one or more example methods, the method 200 comprises sending S202, to the network node, a capability message indicative of a capability of the WD to use interference mitigation techniques, such as restarting, resetting, or adapting interference calculations, to improve communication. The capability message may indicate that the WD is an advanced receiver capable of performing interference mitigation and/or cancellations, such as based on interference calculations. In one or more example methods, the capability of the WD to use interference mitigation techniques is indicated based on a class, such as a category, of the WD. In one or more example methods, the capability of the WD to use interference mitigation techniques may be indicated as a response to a capability inquiry, such as a UE capability inquiry, from the network node in a certain band or a band combination, such as a frequency band or a frequency band combination.

The method 200 comprises receiving S204, from the network node, a message indicating that a change of an interference state in a network will occur.

The interference state may herein be seen as an interference level, such as an interference signal strength, and/or a spatial structure of the interference experienced by the wireless device. The message indicating the interference state may thus be indicative of a change in the interference level and/or a spatial structure of the interference experienced by the wireless device.

The message indicating that a change of an interference state in the communications network will occur can inform the WD about the possibility of a change in interference observed by the WD. The change in interference observed by the WD may be due to one or more of a change in the network node configuration, a change in a network node transmit (Tx) beam, a change of a network configuration, such as adding or removing a CED or a new network node joining the network, or due to a configuration change of a CED controlled by the network node.

In one or more example methods, the change of the interference state is associated with a transition between a first interference state and a second interference state.

In one or more example methods, the change of the interference state is associated with the coverage enhancing device, CED, in the communications network. The first interference state may be caused by a first configuration of the CED, and the second interference state may be caused by a second configuration of the CED. The first configuration of the CED may be an ON-state of the CED. The second configuration of the CED may be an OFF-state of the CED. The first interference state may be an ON-state of the CED. The second interference state may be an OFF-state of the CED.

In one or more example methods, the first interference state may be caused by the CED performing nulling and the second interference state may be caused by the CED not performing nulling. Nulling means that an antenna array of the CED may use a phase distribution to have minimum signal level in a predetermined direction.

In one or more example methods, the message is indicative of a pattern of one or more transitions between the first interference state and the second interference state. The pattern may indicate at which times a transition between the first interference state and the second interference state may occur. In one or more example methods, the pattern may be associated with the transitions of the CED from a first state, such as from a first configuration of the CED, to a second state, such as to a second configuration of the CED, as shown in FIG. 6.

In one or more example methods, the pattern is indicative of one or more of a duration of the first interference state and a duration of the second interference state. The duration of the first interference state and/or the second interference state may be an ON duration and/or OFF duration of the CED.

In one or more example methods, the message is indicative of a time instance when the change of the interference state will occur. The time instance may be indicated as a time offset from the transmission of the message, such as a time offset from a time stamp of the message.

In one or more example methods, the message is indicative of one or more beamforming pattern used or to be used at the CED during the first state or the second state. The beamforming pattern may be implicitly or explicitly indicated in the message. The different beamforming patterns of the CED results in the CED redirecting signals in different directions. Hence, the interference situation experienced by the WD may change.

In one or more example methods, the message is transmitted using one or more of a physical (PHY) layer signaling using downlink control information (DCI), a medium access control-control element (MAC-CE) signaling, and/or a Radio Resource Control (RRC) signaling.

The method 200 comprises adapting S206 an interference measurement based on the indicated change of the interference state.

In one or more example methods, adapting S206 comprises restarting S206A an interference estimation based on the indicated change of interference state. Restarting the interference estimation may comprise starting a new covariance matrix measurement as disclosed in FIG. 6. The new covariance matrix estimation may be started at the transitions between the inference states as indicated by the message received from the network node. Based on the message indicating that a change of an interference state in the network will occur, the wireless device may take a certain action, such as terminating an ongoing window of interference covariance matrix computation and may start a computation of a new interference covariance matrix. When the message comprises a pattern indicating transitions between interference states, such as of interference signal strengths, the WD may start a new interference covariance matrix computation at each transition in the indicated pattern as shown in FIG. 6. In one or more example methods, the WD may keep, such as store, more than one independent covariance matrix estimate, one for each of the distinct interference states. An advantage is that the covariance matrix estimation will be matched to the interference pattern observed at the wireless device which can lead to performance improvements in the communication by the WD.

In the scenario shown in FIG. 2A the received signal at the WD 300 when the CED is in a first state, herein depicted as an OFF-state, can be expressed as:

$${y}_{OFF} = {H}_{d} {x}_{d} + {H}_{{I}_{3}} {x}_{{I}_{3}} + {n}_{1} , \qquad ( 1 )$$

where H_{d} denotes an effective channel matrix from the first network node 400A to the WD 300 and x_{d} is the desired signal transmitted by the first network node 400A to the WD 300. H_{I}_{₃} denotes the channel matrix from the third network node 400C in cell 3 to the WD 300 and x_{I}_{₃} is the interfering signal. The symbol n₁ denotes noise, such as an Additive white Gaussian noise (AWGN).

It can be assumed that E[x_{d}x_{d}^{H}]=I, E[x_{I}_{₃}x_{I}_{₃}^{H}]=I and E[x_{d}x_{I}_{₃}^{H}]=0

Assuming that x_{d} is decoded correctly at the WD 300, the WD 300 can compute the interference-plus-noise-plus-channel estimation error covariance as

$${R}_{I + N + CE , OFF} = E [ ( {y}_{OFF} - {\hat{H}}_{d} {x}_{d} ) {( {y}_{OFF} - {\hat{H}}_{d} {x}_{d} )}^{H} ] = {R}_{C E R} + {R}_{{I}_{3}} + {R}_{n} , \qquad ( 2 )$$

where the estimation or sample averaging can typically be performed at the WD 300 over multiple slots or multiple symbols of a slot. In equation (2), R_{CER}=E[(H_{d}−Ĥ_{d}) (Ĥ_{d}−Ĥ_{d})^{H}] denotes a covariance matrix associated with the channel estimation error, R_{I}_{₃}=E[H_{I}_{₃}H_{I}_{₃}^{H}] denotes a covariance of the interfering channel matrix associated with the third network node 400C, and Rₙ=E[n₁n₁^{H}] denotes a noise covariance matrix.

The covariance matrix in equation (2) may then be used to pre-whiten the received signal y_{OFF} to improve the probability of detection of x_{d}.

Now if the CED is in a second state, such as in an ON state as shown in FIG. 2B, the received signal at the WD 300 can be expressed as

$${y}_{ON} = {H}_{d} {x}_{d} + {H}_{{I}_{3}} {x}_{{I}_{3}} + {H}_{{I}_{2}} {x}_{{I}_{2}} + {n}_{2} \qquad ( 3 )$$

It can be noted that there is a new interference signal from the second network node 400B in cell 2 that also contributes to the received signal y_{ON} at the WD 300. If the WD 300 uses the R_{I+N+CE,OFF} from equation (2) to pre-whiten y_{ON}, the performance will degrade as the interference contribution from H_{I}_{₂} is not considered in R_{I+N+CE,OFF} in equation (2).

According to the current disclosure, if the WD 300 receives a signaling about the change in interference strength when the CED turns to the ON-state, the WD 300 can start a new covariance matrix measurement as shown in FIG. 6 and may compute the R_{I+N+CE,ON} in a similar way as the computation of R_{I+N+CE,OFF} and use it for decoding the desired data during the CED ON-state. In one or more example methods, instead of starting a new covariance matrix computation R_{I+N+CE,ON}, the network node 300 may use R_{I+N+CE,OFF} and only do the estimation of R_{I}_{₂}=E[H_{I}_{₂}H_{I}_{₂}^{H}] and use it in conjunction with R_{I+N+CE,OFF} to decode the desired data during CED ON-state.

FIG. 7 shows a block diagram of an example network node 400 according to the disclosure. The network node 400 comprises memory circuitry 401, processor circuitry 402, and a wireless interface 403. The network node 400 may be configured to perform any of the methods disclosed in FIG. 4. In other words, the network node 400 may be configured for improving communication by a wireless device, WD.

The network node 400 is configured to transmit, such as via the wireless interface 300, to the WD, a message indicating that a change of an interference state in the communications network, such as a change of an interference level experienced by the WD, will occur.

The wireless interface 403 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M, millimeter-wave communications, such as millimeter-wave communications in licensed bands, such as device-to-device millimeter-wave communications in licensed bands.

Processor circuitry 402 is optionally configured to perform any of the operations disclosed in FIG. 4 (such as any one or more of S102, S102A, S104, S106, S106A, S106B, S106C). The operations of the network node 400 may be embodied in the form of executable logic routines (for example, lines of code, software programs, etc.) that are stored on a non-transitory computer readable medium (for example, memory circuitry 401) and are executed by processor circuitry 402).

Furthermore, the operations of the network node 400 may be considered as a method that the network node 400 is configured to carry out. Also, while the described functions and operations may be implemented in software, such functionality may also be carried out via dedicated hardware or firmware, or some combination of hardware, firmware and/or software.

Memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 7). Memory circuitry 401 is considered a non-transitory computer readable medium.

Memory circuitry 401 may be configured to store information (such as capability information, network configurations, CES configurations, and/or information about changes of an interference state in the network) in a part of the memory.

FIG. 8 shows a block diagram of an example wireless device 300 according to the disclosure. The wireless device 300 comprises memory circuitry 301, processor circuitry 302, and a wireless interface 303. The wireless device 300 may be configured to perform any of the methods disclosed in FIG. 5. In other words, the wireless device 300 may be configured for performing interference measurements.

The wireless device 300 is configured to receive, such as via the wireless interface 303, from the network node, a message indicating that a change of an interference state in a network will occur.

The wireless device 300 is configured to adapt an interference measurement based on the indicated change of the interference state.

The wireless interface 303 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M, millimeter-wave communications, such as millimeter-wave communications in licensed bands, such as device-to-device millimeter-wave communications in licensed bands.

The wireless device 300 is optionally configured to perform any of the operations disclosed in FIG. 5 (such as any one or more of S202, S204, S206, S206A). The operations of the wireless device 300 may be embodied in the form of executable logic routines (for example, lines of code, software programs, etc.) that are stored on a non-transitory computer readable medium (for example, memory circuitry 301) and are executed by processor circuitry 302).

Furthermore, the operations of the wireless device 300 may be considered as a method that the wireless device 300 is configured to carry out. Also, while the described functions and operations may be implemented in software, such functionality may also be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 8). Memory circuitry 301 is considered a non-transitory computer readable medium.

Memory circuitry 301 may be configured to store information (such as capability information and/or information about changes of an interference state in the network) in a part of the memory.

Examples of methods and products (network node and wireless device) according to the disclosure are set out in the following items:
Item 1. A method performed by a network node of a communications network, for improving communication by a wireless device, WD, wherein the method comprises:
   transmitting (S106), to the WD, a message indicating that a change of an interference state in the communications network will occur.
Item 2. The method according to Item 1, wherein the change of the interference state is associated with a transition between a first interference state and a second interference state.
Item 3. The method according to Item 2, wherein the message is indicative of a pattern of one or more transitions between the first interference state and the second interference state.
Item 4. The method according to Item 3, wherein the pattern is indicative of one or more of a duration of the first interference state and a duration of the second interference state.
Item 5. The method according to any one of the previous Items, wherein the message is indicative of a time instance when the change of the interference state will occur.
Item 6. The method according to any one of the previous Items, wherein the message is transmitted using one or more of:
   physical, PHY, layer signaling,
   medium access control-control element, MAC-CE, signaling, and
   Radio Resource Control, RRC, signaling.
Item 7. The method according to any one of the previous Items, wherein the change of the interference state is associated with a coverage enhancing device, CED, in the communications network.
Item 8. The method according to Item 7, wherein the first interference state is due to a first configuration of the CED, and the second interference state is due to a second configuration of the CED.
Item 9. The method according to Item 8, wherein the first configuration is an ON-state of the CED, and the second configuration is an OFF-state of the CED.
Item 10. The method according to any one of the previous Items, wherein the method comprises:
   obtaining (S102) information about the change of interference state in the communications network.
Item 11. The method according to any one of the previous Items, wherein the method comprises:
   receiving (S104), from the WD, a capability message indicative of the WD being able to use interference calculations to improve communication.
Item 12. The method according to Item 11, wherein transmitting (S106) comprises transmitting (S106A) the message based on the capability message.
Item 13. The method according to any one of the previous Items, wherein transmitting (S106) comprises transmitting (S106B) a unicast message.
Item 14. The method according to any one of the Items 1-12, wherein transmitting (S106) comprises broadcasting (S106C) the message.
Item 15. A method performed by a wireless device, WD, for performing interference measurements by the WD, wherein the method comprises:
   receiving (S204), from the network node, a message indicating that a change of an interference state in a network will occur, and
   adapting (S206) an interference measurement based on the indicated change of the interference state.
Item 16. The method according to Item 15, wherein the change of the interference state is associated with a transition between a first interference state and a second interference state.
Item 17. The method according to Item 16, wherein the message is indicative of a pattern of one or more transitions between the first interference state and the second interference state.
Item 18. The method according to Item 17, wherein the pattern is indicative of one or more of a duration of the first interference state and a duration of the second interference state.
Item 19. The method according to any one of the Items 15 to 18, wherein the message is indicative of a time instance when the change of the interference state will occur.
Item 20. The method according to any one of the Items 15 to 19, wherein the message is received using one or more of:
   physical, PHY, layer signaling,
   medium access control-control element, MAC-CE, signaling, and
   Radio Resource Control, RRC, signaling.
Item 21. The method according to any one of the Items 15 to 20, wherein the change of the interference state is associated with a coverage enhancing device, CED, in the communications network.
Item 22. The method according to Item 21, wherein the first interference state is due to a first configuration of the CED, and the second interference state is due to a second configuration of the CED.
Item 23. The method according to Item 22, wherein the first configuration is an ON-state of the CED, and the second configuration is an OFF-state of the CED.
Item 24. The method according to any one of the Items 15-23, wherein the method comprises:
   sending (S202), to the network node, a capability message indicative of a capability of the WD to use interference calculations to improve communication.
Item 25. The method according to Item 24, wherein the capability of the WD to use interference calculations is indicated based on class of the WD.
Item 26. The method according to any one of the Items 15-23, wherein adapting (S206) comprises restarting (S206A) an interference estimation based on the indicated change of interference state.
Item 27. A network node comprising memory circuitry, processor circuitry, and a wireless interface, wherein the radio network node is configured to perform any of the methods according to any of Items 1-14.
Item 28. A wireless device comprising memory circuitry, processor circuitry, and a wireless interface, wherein the wireless device is configured to perform any of the methods according to any of Items 15-26.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-8 comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value. For example, within less than or equal to 10 wt./vol. % of, within less than or equal to 5 wt./vol. % of, within less than or equal to 1 wt./vol. % of, within less than or equal to 0.1 wt./vol. % of, and within less than or equal to 0.01 wt./vol. % of the stated amount.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method performed by a network node of a communications network, for improving communication by a wireless device (WD) wherein the method comprises:
transmitting, to the WD, a message indicating that a change of an interference state in the communications network will occur.

2. The method according to claim 1, wherein the change of the interference state is associated with a transition between a first interference state and a second interference state.

3. The method according to claim 2, wherein the message is indicative of a pattern of one or more transitions between the first interference state and the second interference state.

4. The method according to claim 3, wherein the pattern is indicative of one or more of a duration of the first interference state and a duration of the second interference state.

5. The method according to claim 1, wherein the message is indicative of a time instance when the change of the interference state will occur.

6. The method according to claim 1, wherein the message is transmitted using one or more of:
physical (PHY) layer signaling,
medium access control-control element (MAC-CE) signaling, and
Radio Resource Control (RRC) signaling.

7. The method according to claim 1, wherein the change of the interference state is associated with a coverage enhancing device (CED) in the communications network.

8. The method according to claim 7, wherein a first interference state is due to a first configuration of the CED, and a second interference state is due to a second configuration of the CED.

9. The method according to claim 7, wherein the first configuration is an ON-state of the CED, and the second configuration is an OFF-state of the CED.

10. The method according to claim 1, wherein the method comprises:
obtaining information about the change of interference state in the communications network.

11. The method according to claim 1, wherein the method comprises:
receiving, from the WD, a capability message indicative of the WD being able to use interference calculations to improve communication.

12. The method according to claim 11, wherein transmitting comprises transmitting the message based on the capability message.

13. The method according to claim 1, wherein transmitting comprises transmitting a unicast message.

14. The method according to claim 1, wherein transmitting comprises broadcasting the message.

15. A method performed by a wireless device (WB) for performing interference measurements by the WD, wherein the method comprises:
receiving, from the network node, a message indicating that a change of an interference state in a network will occur, and
adapting an interference measurement based on the indicated change of the interference state.

16. The method according to claim 15, wherein the change of the interference state is associated with a transition between a first interference state and a second interference state.

17. The method according to claim 16, wherein the message is indicative of a pattern of one or more transitions between the first interference state and the second interference state.

18. The method according to claim 17, wherein the pattern is indicative of one or more of a duration of the first interference state and a duration of the second interference state.

19. The method according to claim 15, wherein the message is indicative of a time instance when the change of the interference state will occur.

20. The method according to claim 15, wherein the message is received using one or more of:
physical (PHY) layer signaling,
medium access control-control element (MAC-CE) signaling, and
Radio Resource Control (RRC) signaling.

21-28. (canceled)
